(19) United States
(12) Patent Application Publication
(10) Pub. No.: US 2014/0102432 A1
(43) Pub. Date: Apr. 17, 2014

(54) Cooling System For Concrete Saw

(71) Applicant: Diamond Products, Limited, Elyria, OH (US)

(72) Inventor: Brian S. Edwards, Amherst, OH (US)

(73) Assignee: Diamond Products, Limited, Elyria, OH (US)

(21) Appl. No.: 14/055,033

(22) Filed: Oct. 16, 2013

Related U.S. Application Data
(60) Provisional application No. 61/714,262, filed on Oct. 16, 2012.

(51) Int. Cl. B28D 1/04; F16H 37/06

(52) U.S. Cl. CPC B28D 1/04; F16H 37/065
USPC 125/13.01; 74/15.8

(57) ABSTRACT

A concrete saw includes a generally rectangular frame having a front end, a rear end and a longitudinal length. An engine is supported by the frame. The engine includes a rotational output shaft aligned generally transverse to the longitudinal length of the frame. A saw blade is rotatably connected to the frame and driven by the output shaft of the engine. A cooling system is mounted to a front part of the engine. The cooling system includes a radiator and a cooling fan. The cooling fan is driven by a fan drive assembly having a drive shaft configured as a power take-off to be continuously driven by the engine.

The present application claims priority to U.S. Provisional Patent Application Ser. No. 61/714,262, filed on Oct. 16, 2012, the disclosure of which is incorporated herein by reference.

### BACKGROUND

Exemplary embodiments herein generally relate to a road or floor saw, and more particularly, to a cooling system for a self-propelled operator-guided or steerable concrete saw.

In the concrete industry, when building bridges, buildings, roads and the like, it is often necessary to pour large horizontal slabs of concrete. Once poured, it is usually necessary to machine the slab. Such machining may include cutting seams completely through the slab (to form expansion joints and to allow for foundation shifting), cutting notches partially into the slab (to create stress cracks along which the slab will split), cutting multiple grooves into the slab to create a high friction surface such as for bridges, grinding the surface of the slab and the like. Concrete saws are also used in the demolition or removal of concrete, such as during the sawing and replacement of bridge decks. Various types of concrete saws may be utilized to carry out these machining and demolition tasks. In larger industrial applications, large self-propelled saws are used that are powered in a variety of manners, such as by gasoline, diesel, electric, propane and natural gas engines mounted on the saw. While performing a cut, the operator controls the direction, cutting speed, cutting depth and the like.

Conventional concrete saws include a gasoline, diesel, propane (internal combustion), hydraulic or electric engine for powering the saw blade. FIG. 1 depicts an internal combustion engine 100 for use with a concrete saw. With the internal combustion engine 100, a cooling system 102 for the engine, which includes a cooling fan 104 and a radiator (not shown), is located on a side part of the engine. This position for the cooling system is not desirable for a conventional concrete saw because the engine is typically mounted along an axis transverse to the longitudinal axis of the saw frame. This transverse arrangement aligns the engine output shaft or crankshaft parallel to the rotational axis of the saw blade, to afford an easy design for interconnecting pulleys upon the crankshaft and the saw blade. With the transverse alignment, the cooling fan 104 and radiator would be located above the saw blade thereby significantly increasing the width of the concrete saw. The cooling fan 104 can be belt driven by the engine through a power take-off, which can also drive an auxiliary device, such as an alternator 110 and a pump (not shown) to which the fan 110 is connected. However, this configuration can become complicated if the cooling fan is located on the same side part of the engine as the output shaft, as depicted in FIG. 1. This side position of the cooling fan 104 can require the belt to do a ninety degree twist or turn or can require the use of two belts with a right angle gear drive in-between. Remote mounting the cooling fan and radiator can also be accomplished by powering the fan with an electric or hydraulic motor; however, the use of these motors can increase the cost of the concrete saw.

### BRIEF DESCRIPTION

In accordance with one aspect, a concrete saw comprises a generally rectangular frame having a front end, a rear end and a longitudinal length. An engine is supported by the frame. The engine includes a rotational drive shaft aligned generally transverse to the longitudinal length of the frame. A saw blade is rotatably connected to the frame and driven by the drive shaft of the engine. A cooling system includes a radiator and a cooling fan mounted to and facing a front part of the engine. The cooling fan is driven by a fan drive assembly mounted to the front part of the engine and having an input shaft configured as a power take-off to be continuously driven by the engine.

In accordance with another aspect, a power take-off assembly configured to be continuously driven by an engine comprises a one-piece drive housing for housing an input shaft and a separate output shaft. Each of the input shaft and the output shaft has a proximal end portion and a distal end portion. A first bevel gear is connected to the distal end portion of the input shaft and a second bevel gear is connected to the proximal end portion of the output shaft. The first bevel gear engages the second bevel gear whereby rotation of the input shaft rotates the output shaft. A rotational axis of the input shaft is substantially perpendicular to a rotational axis of the output shaft.

In accordance with yet another aspect, a concrete saw comprises a generally rectangular frame having a front end, a rear end and a longitudinal length. An engine is supported by the frame. The engine includes a rotational drive shaft aligned generally transverse to the longitudinal length of the frame. A saw blade is rotatably connected to the frame and driven by the drive shaft of the engine. A cooling system includes a radiator and a cooling fan mounted to and facing a front part of the engine. The cooling fan is driven by a fan drive assembly mounted to the front part of the engine. The fan drive assembly has an input shaft configured as a power take-off to be continuously driven by the engine and an output shaft connected to the cooling fan. A rotational axis of the input shaft is aligned with a rotational axis of the drive shaft and is substantially perpendicular to a rotational axis of the output shaft. A one-piece, substantially L-shaped drive housing houses the input shaft and the separate output shaft.

### BRIEF DESCRIPTION OF THE DRAWINGS

FIG. 1 is a perspective view of an internal combustion engine for a concrete saw with a cooling fan of a cooling system operably mounted on a side part of the engine.

FIGS. 2 and 3 are perspective views of a concrete saw including the internal combustion engine of FIG. 1 with a cooling system according to the present disclosure operably mounted on a front part of the engine.

FIGS. 4-6 are perspective views of the engine and cooling system shown in FIGS. 2 and 3.

FIG. 7 is a perspective view of an exemplary fan drive assembly of the cooling system of FIG. 6.

FIG. 8 is an exploded perspective view of the fan drive assembly of FIG. 7 including a cooling fan according to one aspect of the present disclosure.

FIG. 9 is a front view of the cooling fan mounted to the fan drive assembly of FIG. 7.

FIG. 10 is a cross-sectional view of FIG. 9 taken along line X-X of FIG. 9.

FIG. 11 is an exploded perspective view of the fan drive assembly of FIG. 7 including a cooling fan according to another aspect of the present disclosure.

### DETAILED DESCRIPTION

It should, of course, be understood that the description and drawings herein are merely illustrative and that various modifications and changes can be made in the structures disclosed without departing from the present disclosure. In general, the figures of the exemplary cooling system for a concrete saw are not to scale. It will also be appreciated that the various identified components of the exemplary cooling system for a concrete saw disclosed herein are merely terms of art that may vary from one manufacturer to another and should not be deemed to limit the present disclosure.

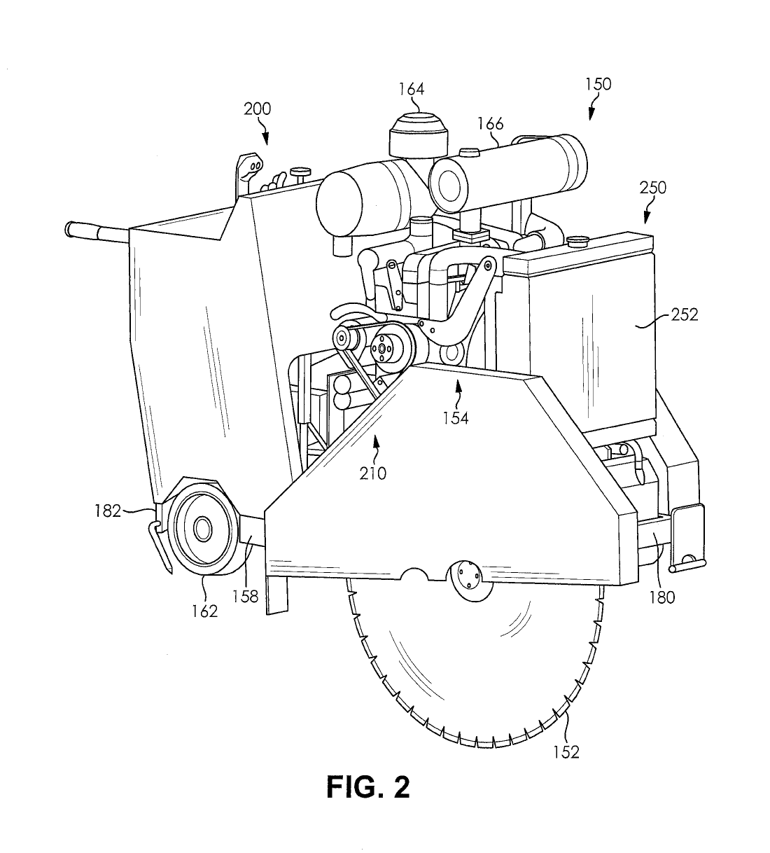

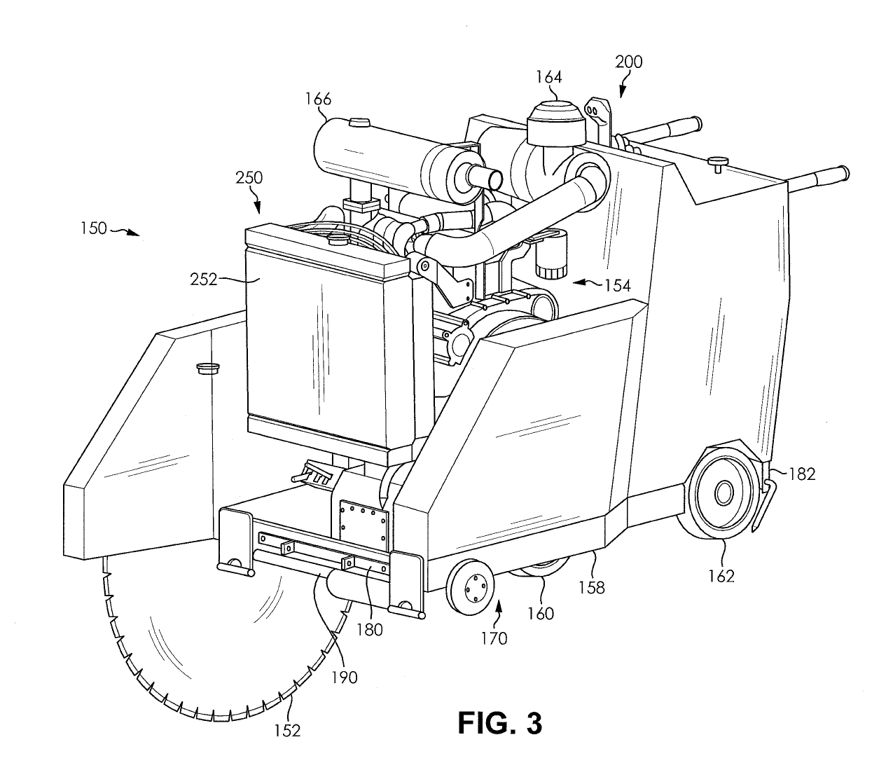

Referring now to the drawings, wherein like numerals refer to like parts throughout the several views, FIGS. 2 and 3 illustrate a concrete saw 150 for cutting seams, notches and/or grooves into or through asphalt, concrete, stone or other similar surfaces concrete, asphalt, stone and other hardened surfaces according to the present disclosure. The concrete saw 150 includes an implement or blade 152, an engine 154 for driving the saw blade 152, a frame 158 for supporting the engine 154 and a set of front wheels 160 and rear wheels 162. The saw 150 is preferably a self-propelled saw, and thus the rear wheels 162 are driven in a conventional manner (e.g., a hydraulic drive system or other like system). However, it will be appreciated that saw 150 could be a push-type saw. It will also be appreciated that the engine 154 may comprise a gasoline, diesel or propane (internal combustion) engine, hydraulic and air engine, or an electrical motor. The engine 154 further includes an air cleaner 164 and a muffler 166, as is known in the art.

The concrete saw 150 also includes operational systems that are known or conventional in the art. These systems can include a locomotion system that drives the rear wheels 162 supporting the saw frame 158 at a desired speed. A lift system 170 is also included, the lift system being operably connected to the front wheels 160 to tilt or lift the saw frame 158. When tilted the saw blade 152 may be taken out of contact with the substrate being cut. The concrete saw 150 can include an engine mounting system that minimizes vibration within the frame. Additionally, the concrete saw 150 can include some type of dampening mechanism adapted to interrupt direct communication between the engine 154 and saw blade 152 when the blade encounters significant predetermined resistance.

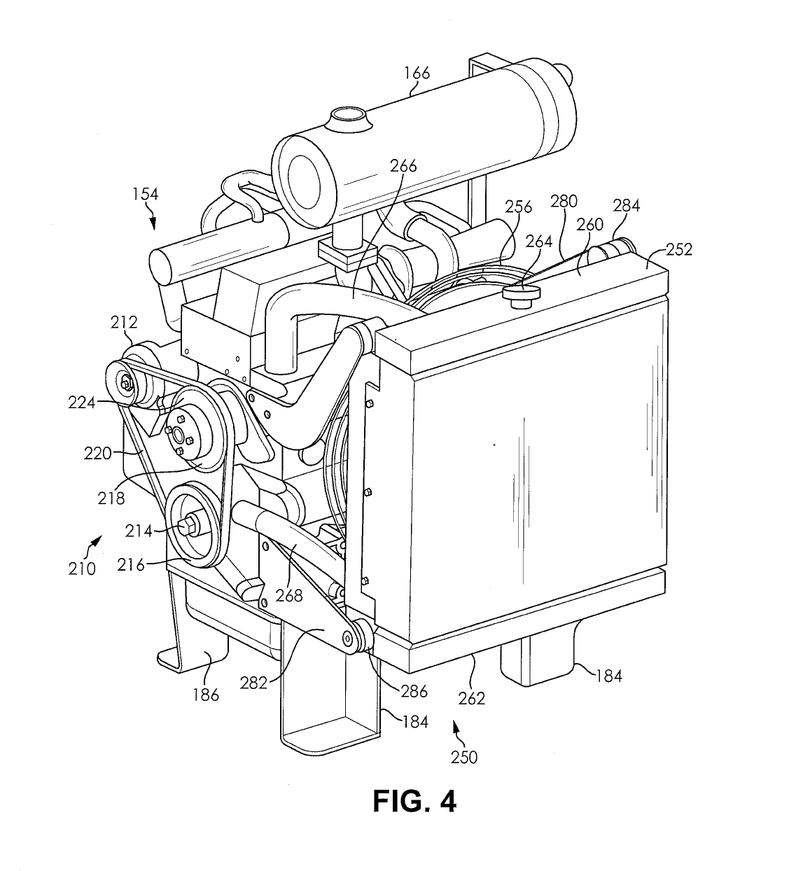

The frame 158 has a front end 180 and a rear end 182. With additional reference to FIG. 4, the engine 154 is attached to the frame 158 by front and rear support plates 184 and 186. The engine 154 is oriented with a driven output shaft (not shown) transverse to a longitudinal axis defined by the length of the frame 158 and located on a side part of the engine 154 opposite the saw blade 152. The output shaft is operably connected with a jack shaft 190 via a drive system or transmission. The transmission can be belt driven for transmitting rotational energy from the engine 154 to the saw blade 152. For example, and as is well known in the art, the transmission can include one or more sprockets, sheave pulleys and belts, such POLYCHAIN® synchronous belts available from the Gates Rubber Company. However, it should be appreciated that the entire saw blade drive system can be beltless. As shown, the jack shaft 190 is oriented substantially parallel with the output shaft of the engine 154 for transmitting power across the front of the concrete saw 150 and to the saw blade 152. Controls 200 are provided at the rear end 182 of the frame 158 for controlling operation of the concrete saw. For example, the controls 200 can include a speed selection lever for controlling the speed of advancement of the saw.

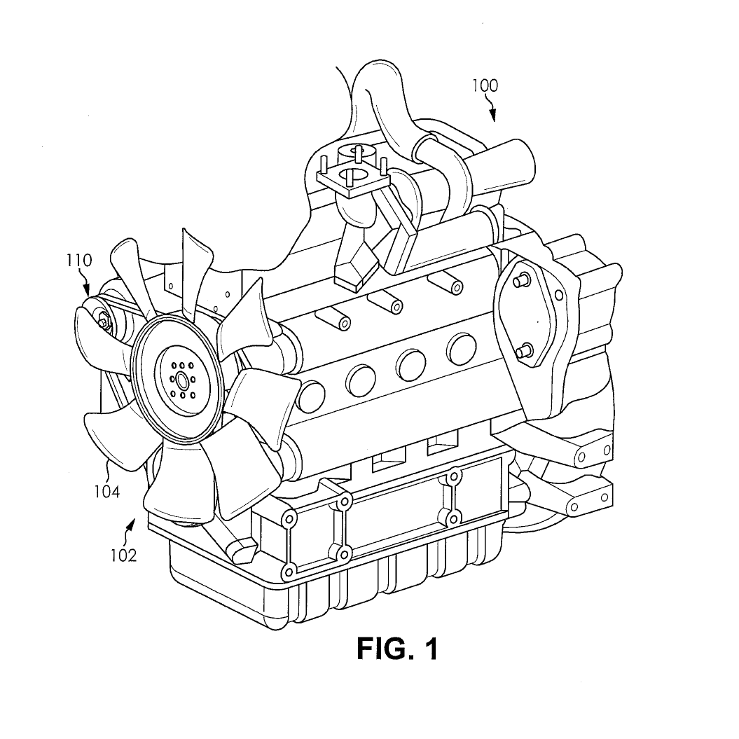

In the depicted embodiment of the concrete saw 150, the engine 154 can be similar to the engine 100 illustrated in FIG. 1, and can include a power take-off 210 for driving an auxiliary device, such as an alternator 212 and a water pump 218, for example. The power take-off 210 is located on a side part of the engine 154 opposite of the side part having the output shaft. The power take-off 210 includes a take-off shaft 214 having an axis parallel to an axis of the engine output shaft and a power input pulley 216 mounted thereto. Each auxiliary device 212, 218 is driven by a belt 220 which is coupled to the pulley 216, a pulley 222 provided on the auxiliary device 212 and a pulley 224 mounted to the auxiliary device 218.

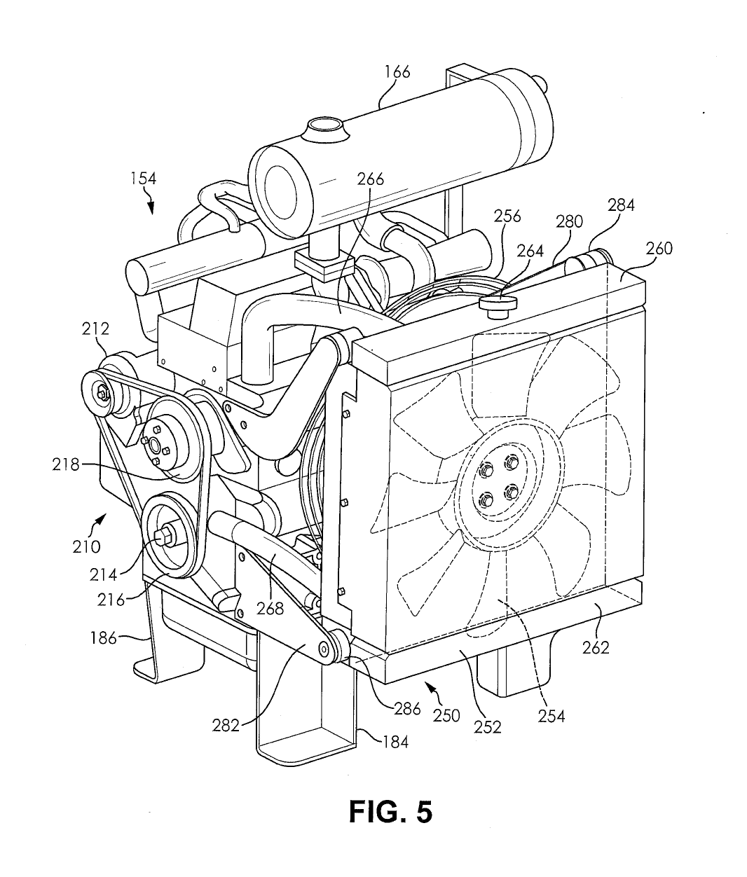

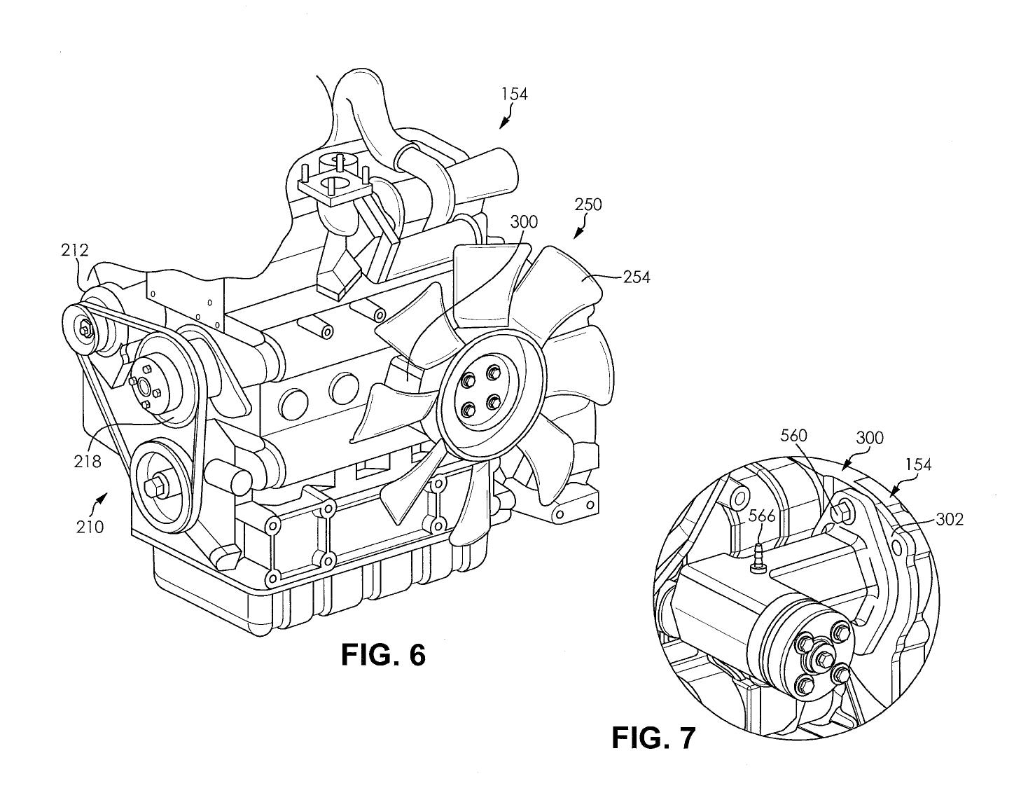

The engine 154 further includes an exemplary cooling system 250 located adjacent to the front end 180 of the frame 158. With particular reference to FIGS. 4-6, the cooling system 250 includes a radiator 252 and a cooling fan 254 disposed directly behind the radiator 252 and forward of a front part of the engine 154. A fan cover 256 can surround the cooling fan 254. The radiator 252 includes a radiator core (not shown) that can have the shape of an approximately square plate, as viewed from the front. The cooling fan 254 can be located along an approximately central portion of the radiator core. Upper and lower tanks 260 and 262 are disposed along the top side and underside of the radiator 252, respectively, and can be joined with the radiator core. As depicted, the radiator 252 is of a down-flow type (vertical flow type). A radiator cap 264 is attached to a water supply port of the upper tank 252. As is well known, the radiator cap 264 can have a built-in pressurization valve and a built-in negative pressure valve, so that it can adjust the flow rate of cooling water circulating through the engine 110 and the radiator 252 so as to keep the cooling water pressure in a prescribed range. An inlet hose 266 is connected to the upper tank 260, and an outlet hose 268 extends from the lower tank 262. As is well known, as the engine 154 is operated and a water pump, such as pump 218, is driven, cooling water circulates through a cooling water passage in the engine 154. Heat of the engine therefore radiates from the radiator core using the cooling water as a medium, and the cooling fan 254 is driven to enhance the heat radiation. Upper and lower supports 280 and 282 secure the radiator 252 to the front part of the engine 154. The supports 280, 282 can be provided with bushing or rubber mounts 284, 286 so that the radiator 254 is elastically mounted to the engine 154.

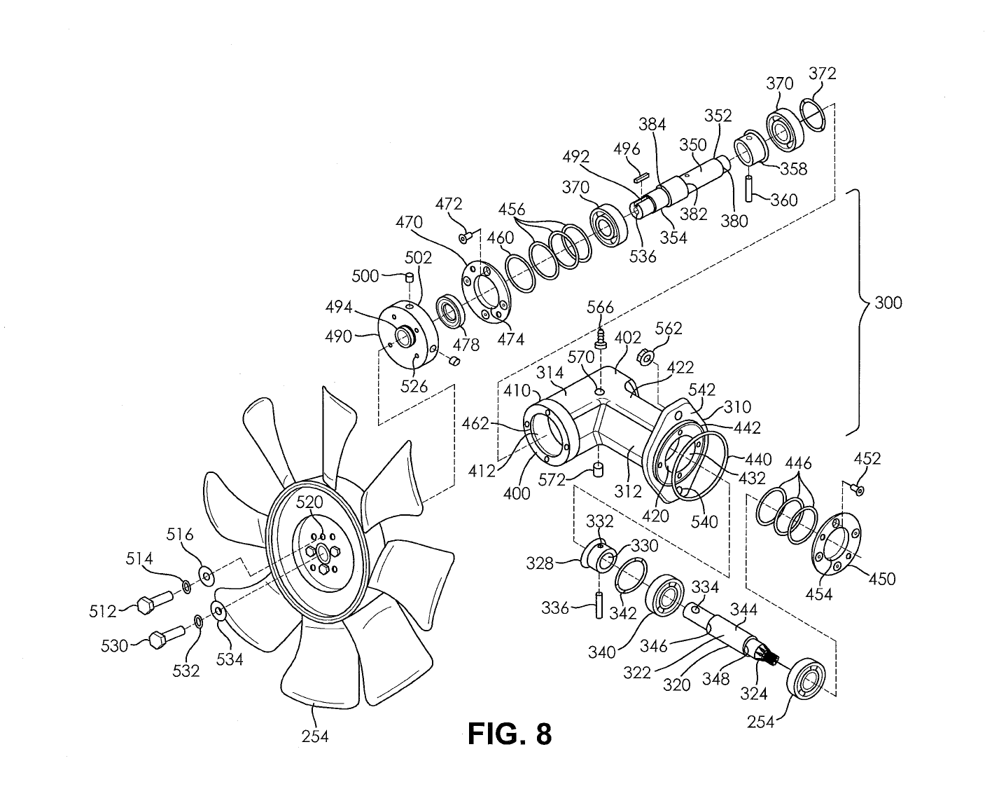

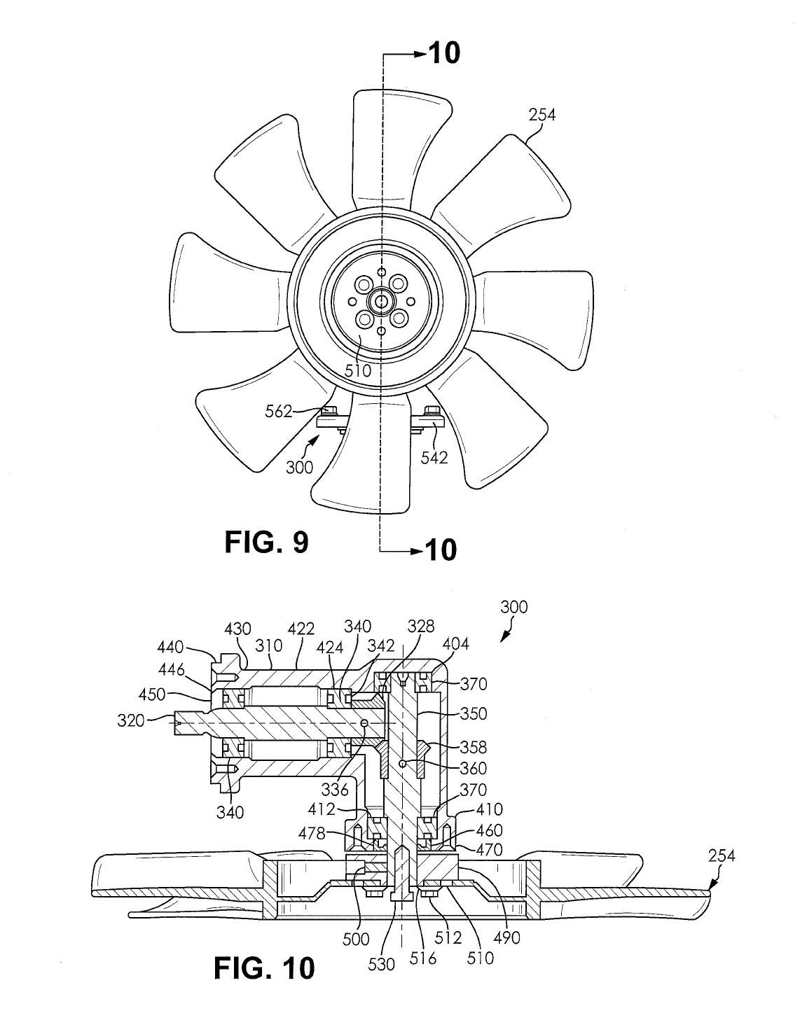

As indicated above, the cooling fan 254 is disposed behind the radiator 252 and is connected to the front part of the engine 154 by an exemplary power take-off assembly of fan drive assembly 300 which is operably mounted on a mount pad 302 provided on an inward forward side of the engine 154 facing the saw blade (FIG. 7). As is well known with concrete saws, the mount pad 302 is typically provided for an auxiliary hydraulic pump. With particular reference to FIGS. 8-10, the fan drive assembly 300 includes a drive housing 310 including a first part 312 and a second part 314 extending substantially perpendicularly from the first part 312. An input or take-off shaft 320 has a distal end portion 322 housed in the first part 312 and a proximal end portion 324 to be driven by the operation of the engine 154. Secured to the distal end portion 322 of the input shaft 320 is a gear, such as the depicted bevel gear 328. Specifically, the bevel gear 328 includes a first bore 330 extending axially therethrough and dimensioned to receive the distal end portion 322 of the input shaft 320, and a second bore 332 having an axis that is substantially normal to an axis of the first bore 330. An aperture 334 corresponding to the size of the second bore 332 is provided on the distal end portion 322. The distal end portion 322 is inserted into the first bore 330 and the aperture 334 is aligned with the second bore 332. A pin 336 is then inserted through the second bore 332 and the aperture 334, the pin securing the bevel gear 328 to the input shaft 320. However, it should be appreciated that alternative manners for securing the bevel gear 328 to the input shaft 320 are contemplated. Distal and proximal bearings 340 are provided on the distal and proximal end portions 322, 324 of the input shaft 320, and a washer 342 can be interposed between the bevel gear 328 and the distal bearing 340. As shown, a central portion 344 of the input shaft can be enlarged as compared to the distal and proximal end portions 322, 324. This difference in dimension provides for radial walls 346 and 348, and these radial walls 346, 348 can serve as stops for the axial placement of the distal and proximal bearings 340 on the input shaft 320.

The fan drive assembly 300 further includes an output shaft 350 having a proximal end portion 352 housed in the second part 314 of the housing 310 and a distal end portion 354 mounted to the cooling fan 254. With the orientation of the first and second parts 312, 314 of the housing 310, the output shaft 350 is positioned such that an axis of the output shaft is substantially perpendicular to an axis of the input shaft 320. A gear, such as the depicted bevel gear 358, is secured to the proximal end portion 352 of the output shaft 350. It should be appreciated that the bevel gear 358 can be secured to the output shaft 350 in a manner similar to the securing of the bevel gear 328 to the input shaft 320, which is by the use of a pin 360. Proximal and distal bearings 370 are provided on the proximal and distal end portions 352, 354 of the output shaft 350 and a washer 372 is located adjacent the proximal bearing such that the proximal bearing is interposed between the bevel gear 358 and the washer 372. Similar to the input shaft 320, the output shaft 350 can be configured with varying radial dimensions along its axis such that radial walls 380, 382, 384 and 386 are defined on the output shaft 350. Radial wall 380 can serve as a stop for the proximal bearing 370, radial wall 382 can act as a stop of the axial placement of the bevel gear 358, and radial wall 384 can serve as a stop for the distal bearing 370.

By way of example only, to assemble the fan drive assembly 300, the distal bearing 342 is positioned on the distal end portion 322 of the input shaft 320 followed by the washer 342. The bevel gears 328, 358 are connected to the respective input and output shafts 320, 350 as described above. The proximal bearing 370 is positioned on the proximal end portion 352 of the output shaft 350 followed by the washer 372. The partially assembled proximal end portion 352 of the output shaft 350 is then inserted into an opening 400 of the second part 314 of the housing. A closed end section 402 of the second part 314 of the housing 310 can define an internal annular ledge 404 having a radial dimension approximately the same as a diameter of the proximal bearing 370 such that the proximal bearing 370 is securely received on the ledge 404. An open end section 410 of the second part 314 of the housing 310 can also define an internal annular ledge 412 having a radial dimension approximately the same as a diameter of the distal bearing 370 such that the distal bearing 370 is securely received on the ledge 412. Thus, with the placement of the bearings 370 on the annular ledges 404, 412, the axis of the output shaft 350 is coaxial with an axis defined by the second part 314.

The partially assembled distal end portion 322 of the input shaft 320 is then inserted into an opening 420 of the first part 314 of the housing 310. An end section 422 of the first part 312 of the housing 310 can define an internal annular ledge 424 having a radial dimension approximately the same as a diameter of the distal bearing 340 such that the distal bearing 370 is securely received on the ledge 424. An open end section 430 of the first part 312 can also define an internal annular ledge 432 having a radial dimension approximately the same as a diameter of the proximal bearing 340 such that the proximal bearing 340 is securely received on the ledge 432. Thus, with the placement of the bearings 370 on the annular ledges 424, 432, the axis of the input shaft 320 is coaxial with an axis defined by the first part 312. Further, once properly positioned in the first part 312, teeth of the bevel gear 328 of the input shaft 320 engage teeth of the bevel gear 358 of the output shaft 350.

A seal or o-ring 440 is then placed on an annular flange 442 extending axially from the open end section 430. Shims 446 are positioned on the annular ledge 432 and a bearing cap 450 is fastened to the open end section 430 of the first part 312 via fasteners 452. As depicted, the bearing cap 450 is at least partially surrounded by the flange 442, and the proximal end portion 324 of the input shaft extends outwardly through an opening 454 on the bearing cap 450. Similarly, shims 456 are positioned on the annular ledge 412, and a seal or o-ring 460 is placed in an annular groove 462 located on the open end section 410 of the second part 314. A bearing cap 470 is fastened to the open end section 410 of the second part 314 via fasteners 472. As depicted, the distal end portion 354 of the output shaft 350 extends outwardly through an opening 474 on the bearing cap 470. A seal 478 is positioned over the distal end portion 354 and is received in the opening 474.

The assembled fan drive assembly 300 can now be mounted to the cooling fan 254. With continued reference to FIGS. 8-10, a fan hub adapter 490 is mounted on the distal end portion 354 of the output shaft 350. In the depicted embodiment, a keyway 492 is formed on the distal end portion 354 and this keyway is aligned with an elongated slot 494 located on the adapter 490. A key 496 is placed in the keyway 492 and the slot 494 is aligned with the key 496 and the adapter 490 is then slid on the distal end portion 354. Set screws 500 are threaded in threaded openings 502 on an annular wall of the adapter 490 and engage the distal end portion 354 of the output shaft 350. The fan hub adapter 490 is then fastened to a hub 510 of the cooling fan 254 via fasteners 512 which extend through lock washers 514 and washers 516 and openings 520 on the hub 510 and threadingly engage openings 526 located on a face of the adapter 490. Finally, the adapter 490 is further secured to the distal end portion 354 via a fastener 530 which extends through a lock washer 532 and a washer 534 threadingly engages an opening 536 located on a face of the distal end portion 354 of the output shaft 350. Again, the above described method for assembling the fan drive assembly 300 is by way of example only and it is contemplated that the above described steps can be rearranged and performed in different orders.

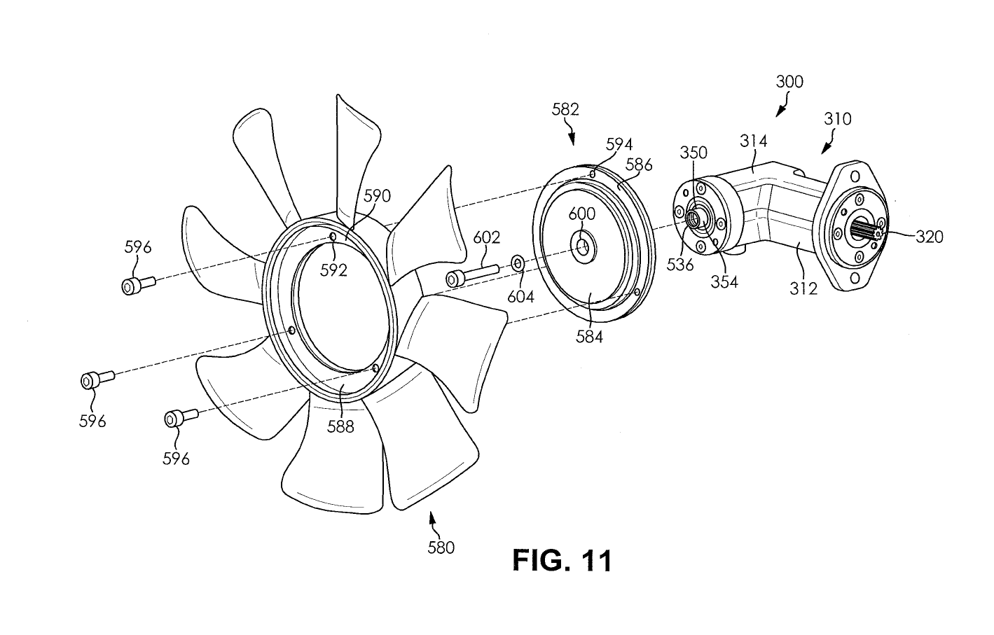

FIG. 11 depicts a cooling fan 580 of the cooling system 250 according to another aspect of the present disclosure. As shown, a fan clutch 582 is provided for mounting the cooling fan 580 to the assembled fan drive assembly 300. The fan clutch 582 includes a housing 584 having an annular flange 586. A hub 588 of the cooling fan 580 defines an opening 590 for at least partially receiving the housing 584. The hub is provided with spaced apertures 592 which can be aligned with threaded apertures 594 located on the annular flange 586. Fasteners 596 extend through the apertures 592 and threadingly engage the apertures 594 thereby securing the fan clutch 582 to the hub 588 of the cooling fan 580. An opening 600 extends through the housing 584. A fastener 602 extends through a lock washer 604 and the opening 600 and threadingly engages the opening 536 located on the face of the distal end portion 354 of the output shaft 350.

The fan clutch 582 is configured to be one of disengaged or only partially engaged at a predetermined first cooling system temperature and engaged at a predetermined second higher cooling system temperature. In the partially engaged condition of the fan clutch 582 the cooling fan 580 rotates at a first speed and in the engaged position of the fan clutch 582 the cooling fan 580 rotates at a second faster speed. The second rotational speed can be less than a rotational input speed of the fan drive assembly 300. According to one aspect, the fan clutch 582 is a viscous thermal clutch configured to be disengaged or only partially engaged when cold, thereby rotating the cooling fan 580 at a slow speed. As the engine coolant heats up, the radiant heat from the radiator 252 causes the fan clutch 582 to engage (for example, around 180° F.). According to one embodiment, the cooling fan 580 only rotates at approximately 75% of the input speed of the fan drive assembly 300 when the fan clutch 582 is fully engaged. The fan clutch 582 then disengages or is only partially engaged once the radiator 252 is adequately cooled by the cooling fan 580. By use of the cooling fan 580 with the fan clutch 582 torsional vibrations and resonance that can be caused by operation of the fan drive assembly 300 can be dampened.

Once assembled, the fan drive assembly 300 is secured to the mount pad 302 provided on an inward forward side of the engine 154 which faces the saw blade 152 (FIG. 7) by first positioning openings 540 of a mounting flange 542 of the first housing part 312 on threaded shafts 560 extending from the pad 302 and then threading nuts 562 onto the shafts 560. It should also be appreciated that the by using the auxiliary hydraulic pump mount pad 302, pressurized oil flow of the engine can be supplied to the bevel gears 328, 358 and the bearings 340, 370 via a hydraulic fitting 566 threaded in an aperture 570 located on the housing 310. A plug 572 is also provided on the housing 310 for the removal of the oil from the housing 310. Further, oil is prevented from leaking between the face of the mount pad 302 and the flange 542 by the seal 440 which sealing engages the mount pad. With the use of the fan drive assembly 300 as a power take-off from the engine 154, the cooling system 250 can be located at the front part of the engine 154 which provides for a compact layout of the concrete saw 150.

It will be appreciated that various of the above-disclosed and other features and functions, or alternatives thereof, may be desirably combined into many other different systems or applications. By way of example, it should be appreciated that the fan drive assembly can be implemented on engines for power equipment other than a concrete saw. Also that various presently unforeseen or unanticipated alternatives, modifications, variations or improvements therein may be subsequently made by those skilled in the art which are also intended to be encompassed by the present disclosure.

What is claimed is:

1. A concrete saw comprising:
a frame having a front end, a rear end and a longitudinal length;
an engine supported by the frame and including a drive shaft aligned transverse to the longitudinal length of the frame;
a saw blade rotatably connected to the frame and driven by the drive shaft;
a cooling system including a radiator and a cooling fan mounted to and facing a front part of the engine; and
a fan drive assembly for driving the cooling fan, the fan drive assembly mounted to the front part of the engine and having an input shaft configured as a power take-off to be continuously driven by the engine.

2. The concrete saw of claim 1, wherein the fan drive assembly includes a drive housing including a first part and a second part extending substantially perpendicularly from the first part.

3. The concrete saw of claim 2, wherein the input shaft has a proximal end portion extending outwardly from the first part to be driven by operation of the engine and a distal end portion housed in the first part of the drive housing.

4. The concrete saw of claim 3, wherein the fan drive assembly includes a separate output shaft operably connected to the input shaft, the output shaft driving the cooling fan.

5. The concrete saw of claim 4, wherein the output shaft of the fan drive assembly has a proximal end portion housed in the second part of the drive housing and a distal end portion extending outwardly from the second part.

6. The concrete saw of claim 5, wherein a first bevel gear is connected to the distal end portion of the input shaft and a second bevel gear is connected to the proximal end portion of the output shaft of the fan drive assembly, wherein the first bevel gear is engaged to the second bevel gear whereby rotation of the input shaft rotates the output shaft of the fan drive assembly.

7. The concrete saw of claim 6, wherein each of the input shaft and output shaft of the fan drive assembly includes a radial wall which defines a stop for the axial placement of the first and second bevel gears on the respective input and output shafts.

8. The concrete saw of claim 7, further including:
a first proximal bearing located on the proximal end portion of the input shaft of the fan drive assembly and a first distal bearing located on the distal end portion of the input shaft between the radial wall and the first bevel gear, the first distal bearing engaging an internal ledge located in the first part of the drive housing; and
a second proximal bearing located on the proximal end portion of the output shaft of the fan drive assembly and a second distal bearing located on the distal end portion of the output shaft, the second bevel gear positioned between the second proximal bearing and the second distal bearing, the second proximal bearing being received in a closed end section of the second part of the drive housing.

9. The concrete saw of claim 6, wherein the drive housing is provided with a hydraulic fitting for the supply of pressurized oil from the engine to the first and second bevel gears.

10. The concrete saw of claim 4, wherein an axis of the input shaft of the fan drive assembly is parallel to an axis of the engine drive shaft, and an axis of the output shaft of the fan drive assembly is substantially perpendicular to the axis of the input shaft.

11. The concrete saw of claim 1, wherein the fan drive assembly is secured to a mount pad provided on an inward forward side of the engine which faces the saw blade.

12. The concrete saw of claim 1, wherein a rotational axis of the cooling fan is substantially perpendicular to a rotational axis of the input shaft.

13. A power take-off assembly configured to be continuously driven by an engine comprising:
a one-piece drive housing for housing an input shaft and a separate output shaft, each of the input shaft and the output shaft having a proximal end portion and a distal end portion; and
a first bevel gear connected to the distal end portion of the input shaft and a second bevel gear connected to the proximal end portion of the output shaft, the first bevel gear engaging the second bevel gear whereby rotation of the input shaft rotates the output shaft, a rotational axis of the input shaft being substantially perpendicular to a rotational axis of the output shaft.

14. The power take-off assembly of claim 13, wherein the drive housing is substantially L-shaped and includes a first part for housing the distal end portion of the input shaft and a second part for housing the proximal end portion of the output shaft, the second bevel gear being located entirely in the second part and the first bevel gear extending into the second part for engagement with the second bevel gear.

15. The power take-off assembly of claim 13, wherein each of the input shaft and output shaft of the fan drive assembly includes a radial wall which defines a stop for the axial placement of the first and second bevel gears on the respective input and output shafts.

16. The power take-off assembly of claim 15, further including:
a first proximal bearing located on the proximal end portion of the input shaft and a first distal bearing located on the distal end portion of the input shaft between the radial wall and the first bevel gear, the first distal bearing engaging an internal ledge located in the first part of the drive housing for limiting axial movement of the input shaft toward the output shaft; and
a second proximal bearing located on the proximal end portion of the output shaft and a second distal bearing located on the distal end portion of the output shaft, the second bevel gear positioned between the second proximal bearing and the second distal bearing, the second proximal bearing being received in a closed end section of the second part of the drive housing.

17. The power take-off assembly of claim 13 in combination a concrete saw including an engine supported by a frame and having a saw blade drive shaft aligned transverse to a longitudinal length of the frame, and a cooling system including a radiator and a cooling fan facing a front part of the engine, wherein the power take-off assembly is mounted to a mount pad provided on an inward forward side of the engine so that the input shaft to be continuously driven by the engine is aligned with the engine drive shaft, the cooling fan being connected to the output shaft.

18. A concrete saw comprising:
a frame having a front end, a rear end and a longitudinal length;
an engine supported by the frame and including a drive shaft aligned transverse to the longitudinal length of the frame;
a saw blade rotatably connected to the frame and driven by the drive shaft;
a cooling system including a radiator and a cooling fan mounted to and facing a front part of the engine; and
a fan drive assembly for driving the cooling fan, the fan drive assembly being mounted to the front part of the engine and having an input shaft configured as a power take-off to be continuously driven by the engine and a separate output shaft connected to the cooling fan, a rotational axis of the input shaft being aligned with a rotational axis of the drive shaft and being substantially perpendicular to a rotational axis of the output shaft, and the fan drive assembly having a one-piece, substantially L-shaped drive housing for housing the input shaft and the output shaft.

19. The concrete saw of claim 18, wherein a first bevel gear is connected to the input shaft and a second bevel gear is connected to the output shaft, the first bevel gear being engaged to the second bevel gear whereby rotation of the input shaft rotates the output shaft, and wherein the drive housing is provided with a hydraulic fitting for the supply of pressurized oil from the engine to the first and second bevel gears housed in the drive housing.

20. The concrete saw of claim 18, wherein the fan drive assembly is mounted to a mount pad provided on an inward forward side of the engine which faces the saw blade.
